(19) United States
(12) Patent Application Publication
(10) Pub. No.: US 2011/0162623 A1
(43) Pub. Date: Jul. 7, 2011

(54) FUEL INJECTION NOZZLE AND FUEL INJECTION VALVE, AND FUEL INJECTION CONTROL SYSTEM USING THE SAME

(76) Inventors: Tomohiro Hayashi, Aichi-Ken (JP); Osamu Hishinuma, Aichi-ken (JP); Masaharu Ito, Aichi-ken (JP); Akio Tanaka, Aichi-ken (JP); Kazuhiro Omae, Kanagawa-ken (JP)

(21) Appl. No.: 12/996,645

(22) PCT Filed: Jun. 8, 2009
(86) PCT No.: PCT/IB09/05882

§ 371 Date: Dec. 7, 2010

(30) Foreign Application Priority Data
Jun. 12, 2008 (JP) 2008-153955

(51) Int. Cl. F02M 51/00; F16K 31/02

(52) U.S. Cl. 123/472; 239/533.2; 251/129.15

(57) ABSTRACT

Needles include a cylindrical outer needle that is brought into contact with and moved away from a nozzle body (113) to open and close an injection hole (1132) and an inner needle (112), slidably inserted in the outer needle (111), that is moved into and out of a sack-tip-portion space (171). When the inner needle (112) enters the sack-tip-portion space (171) and completely occupies the sack-tip-portion space (171), the fuel injection direction B is made downward relative to the injection-hole central axis C. Thus, it is possible to control the fuel injection direction B by controlling the amount of lift of the inner needle (112).

### BACKGROUND OF THE INVENTION

1. Field of the Invention

The invention relates to a fuel injection nozzle and a fuel injection valve with which it is possible to control the direction in which fuel is injected through injection holes, and to a fuel injection control system using such a fuel injection nozzle or a fuel injection valve.

2. Description of the Related Art

A conventional fuel injection control system controls the direction in which fuel is injected through injection holes by controlling the flow of fuel flowing into the injection holes with the use of the position to which a needle is lifted (see Japanese Patent Application Publication No. 2002-115629 (JP-A-2002-115629), for example). Specifically, when the position to which the needle is lifted is high (the amount of lift is large), the flow of the fuel that flows to the injection holes is sharply bent and the fuel injection direction is upward relative to the central axis of the injection hole. Specifically, the fuel injection direction is gradually changed upward as the needle is lifted.

In a compression ignition internal combustion engine, when the engine is in high-load operation, a pilot injection is performed before the top dead center and a main injection is performed near the top dead center. When the engine is in low or middle-load operation, in view of exhaust gas purification, the pilot injection is performed near the top dead center and the main injection is performed after the top dead center.

If a conventional fuel injection control system is applied to such a compression ignition internal combustion engine, when the engine is in high-load operation, fuel is injected while a piston of the internal combustion engine is ascending (that is, during a compression stroke), the fuel injection direction is gradually changed upward as the piston ascends, so that it is possible to inject fuel into a combustion chamber formed in a top portion of the piston and it is therefore possible to suppress the amount of smoke, HC, etc.

However, when the engine is in low or middle-load operation, fuel is injected while the piston is descending (that is, during an expansion stroke), the fuel injection direction is gradually changed upward as the piston descends, and as a result, fuel is not injected into the combustion chamber in the piston. Thus, problems occur that a fuel spray hits an area of the wall of the combustion chamber in the piston that is not in the target area on the wall to cause increase of the amount of smoke and that a fuel spray constituted of relatively large droplets sticks to the wall surface of a cylinder of the internal combustion engine and/or to a lip portion of the combustion chamber in the piston to cause increase of the amount of HC.

### SUMMARY OF THE INVENTION

The invention makes it possible to inject fuel into a combustion chamber in a piston in either of the case where fuel is injected while the piston is ascending and the case where fuel is injected while the piston is descending.

A first aspect of the invention is a fuel injection nozzle including: a nozzle body in which an injection hole is formed; a cylindrical outer needle, slidably inserted in the nozzle body, that is brought into contact with and moved away from the nozzle body at a seat portion to open and close a fuel supply passage leading to the injection hole; and an inner needle, slidably inserted in the outer needle, that is projected out of and retracted into the outer needle on the injection hole side relative to the seat portion, thereby changing the state of flow of fuel around a portion, at which the injection hole is opened, to change a direction in which the fuel is injected through the injection hole.

With this configuration, when the outer needle is lifted, the injection hole is opened and fuel is injected. Moreover, the inner needle is projected out of and retracted into the outer needle on the injection hole side relative to the seat portion, thereby changing the state of flow of fuel around the portion, at which the injection hole is opened, so that it is possible to change the flow speed distribution of the fuel passing through the injection hole and it is therefore possible to change the direction in which the fuel is injected through the injection hole.

The fuel injection nozzle according to the first aspect may be configured such that a sack is defined, downstream of the seat portion, by the outer needle, the inner needle, and the nozzle body, and the inner needle is switched between a first state in which the inner needle occupies an area of the sack downstream of the portion, at which the injection hole is opened, and a second state in which the inner needle does not occupy the area of the sack.

The flow lines of the fuel that flows into the injection hole differ between the first state and the second state. Specifically, in the first state, the area of the sack downstream of the portion, at which the injection hole is opened, is occupied by the inner needle, so that the fuel directly flows into the injection hole. On the other hand, in the second state, this area is not occupied by the inner needle, so that part of the flow lines of the fuel flowing into the injection hole pass this area. Thus, the state of flow of the fuel around the portion, at which the injection hole is opened, differs between the first state and the second state, and therefore, by switching between these states, it is possible to change the direction in which the fuel is injected through the injection hole.

The fuel injection nozzle according to the first aspect may be configured such that when the inner needle is in the first state, the state of flow of the fuel is such that the fuel flows from the seat portion side directly toward the injection hole, so that the flow speed of the fuel in the injection hole is higher in one side of the injection hole than in the other side of the injection hole that is closer to the seat portion than the one side and, when the inner needle is in the second state, the state of flow of the fuel is such that the fuel flows to the injection hole via the area of the sack downstream of the portion, at which the injection hole is opened, so that the flow speed of the fuel in the injection hole is lower in the one side of the injection hole than in said the other side of the injection hole that is closer to the seat portion than the one side.

When the inner needle is not lifted, the inner needle is in the first state. Thus, in the injection hole, the flow speed distribution is such that the flow speed in the upper area (in the side closer to the seat portion) of the injection hole is low and the flow speed in the lower area (in the side closer to the bottom of the sack) of the injection hole is high, so that the fuel injection direction is downward relative to the central axis of the injection hole.

When the inner needle is lifted, the inner needle is in the second state. Thus, fuel flows into the area downstream of the portion, at which the injection hole is opened, and the direction of the flow of the fuel is then turned around at the bottom of the sack, so that the fuel is made to flow from the bottom side of the sack toward the injection hole. Accordingly, in the injection hole, the flow speed distribution is such that the flow speed in the upper area of the injection hole is high and the flow speed in the lower area of the injection hole is low, so that the fuel injection direction is upward relative to the central axis of the injection hole.

Thus, it is possible to control the fuel injection direction by controlling the amount of lift of the inner needle, and, it is therefore possible to inject fuel into the combustion chamber in the piston in either of the case where the fuel is injected while the piston is ascending and the case where the fuel is injected while the piston is descending.

A second aspect of the invention is a fuel injection nozzle including: a nozzle body in which an injection hole is formed; a cylindrical outer needle that is brought into contact with and moved away from the nozzle body to open and close the injection hole; and an inner needle slidably inserted in the outer needle, wherein: a space that is defined, downstream of a seat portion at which the outer needle and the nozzle body are brought into contact with each other, by the inner needle, the outer needle, and the nozzle body is a sack; an area of the sack into and out of which a tip portion of the inner needle is moved and that is downstream of a portion, at which the injection hole is opened, is a sack-tip-portion space; when the outer needle is lifted and the inner needle is not lifted, fuel flows from the seat portion side directly toward the injection hole, so that a flow speed of the fuel in the injection hole is higher in one side of the injection hole than in the other side of the injection hole that is closer to the seat portion than the one side; and, when the outer needle is lifted and the inner needle is lifted, the fuel flows to the injection hole via the sack-tip-portion space, so that the flow speed of the fuel in the injection hole is lower in the one side of the injection hole than in said the other side of the injection hole that is closer to the seat portion than the one side.

With this configuration, when the outer needle is lifted, the injection hole is opened and fuel is injected. When the inner needle is not lifted, in the injection hole, the flow speed distribution is such that the flow speed in the upper area (in the side closer to the seat portion) of the injection hole is low and the flow speed in the lower area (in the side closer to the bottom of the sack) of the injection hole is high, so that the fuel injection direction is downward relative to the central axis of the injection hole.

On the other hand, when the inner needle is lifted, fuel flows into the sack-tip-portion space, and the direction of the flow of the fuel is then turned around at the bottom of the sack, so that the fuel is made to flow from the bottom side of the sack toward the injection hole. Accordingly, in the injection hole, the flow speed distribution is such that the flow speed in the upper area of the injection hole is high and the flow speed in the lower area of the injection hole is low, so that the fuel injection direction is upward relative to the central axis of the injection hole.

Thus, it is possible to control the fuel injection direction by controlling the amount of lift of the inner needle, and it is therefore possible to inject fuel into the combustion chamber in the piston in either of the case where the fuel is injected while the piston is ascending and the case where the fuel is injected while the piston is descending.

A third aspect of the invention is a fuel injection valve including: a fuel injection nozzle according to any one of the above aspects; a first drive portion that drives the outer needle; and a second drive portion that drives the inner needle.

In the fuel injection valve according to the third aspect, the outer needle may be made of magnetic metal, have at one end a seat surface that is brought into contact with the nozzle body at the seat portion, and have at the other end a first brim portion; the first drive portion may include a solenoid that drives the outer needle by magnetic attractive force; and the first drive portion may be located facing an end surface of the first brim portion on the side opposite to the seat surface side.

In the fuel injection valve according to the third aspect, a closing-direction pressure chamber that applies, to the outer needle, a pressure that urges the outer needle in a closing direction and an opening-direction pressure chamber that applies, to the outer needle, a pressure that urges the outer needle in an opening direction may be provided; and the first drive portion may include a valve element, made of magnetic metal, for reducing the pressure of the closing-direction pressure chamber and a solenoid that attracts the valve element in a valve opening direction when the solenoid is energized.

A fourth aspect of the invention is a fuel injection control system including: the fuel injection valve according to the third aspect; and a control means that controls operation of the first and second drive portions.

With the fourth aspect of the invention, it is possible to control the fuel injection timing, the fuel injection duration, and the fuel injection direction of the fuel injection nozzle or the fuel injection valve.

The fuel injection control system according to the fourth aspect may be configured such that the second drive portion is designed to perform control so that the amount of lift of the inner needle is continuously varied.

With this configuration, it is possible to perform control so that the fuel injection direction of the fuel injection nozzle is continuously varied.

In the fuel injection control system according to the fourth aspect, the second drive portion may include a solenoid that drives the inner needle by magnetic attractive force.

This configuration makes it possible to easily obtain the fuel injection control system according to the fourth aspect that is configured to be able to perform control so that the amount of lift of the inner needle is continuously varied.

The fuel injection control system according to the fourth aspect may be installed in an internal combustion engine in which a piston reciprocates, and the control means may control the second drive portion so that the closer to the top dead center the piston is, the larger the amount of lift of the inner needle is.

With this configuration, the closer to the top dead center the piston is, the more upward the fuel injection direction is made relative to the central axis of the injection hole. Thus, it is possible to inject fuel into the combustion chamber in the piston in either of the case where fuel is injected while the piston is ascending and the case where fuel is injected while the piston is descending.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 shows a schematic sectional view showing a fuel injection control system using a fuel injection nozzle according to a first embodiment of the invention;

FIG. 2 is a schematic sectional view showing a fuel injection direction of the fuel injection valve shown in FIG. 1 under a certain condition;

FIG. 3 is a schematic sectional view showing a fuel injection direction of the fuel injection valve shown in FIG. 1 under another condition;

FIG. 4 is an enlarged sectional view of a main part showing an operational state of the fuel injection valve shown in FIG. 1 under a certain condition;

FIG. 5 is an enlarged sectional view of the main part showing an operational state of the fuel injection valve shown in FIG. 1 under another condition; and

FIG. 6 is a schematic sectional view showing a fuel injection control system using a fuel injection nozzle according to a second embodiment of the invention.

### DETAILED DESCRIPTION OF EMBODIMENTS

Embodiments of the invention will be described below with reference to drawings. Note that the same or equivalent portions of the embodiments described below are designated by the same reference numerals in the drawings.

### First Embodiment

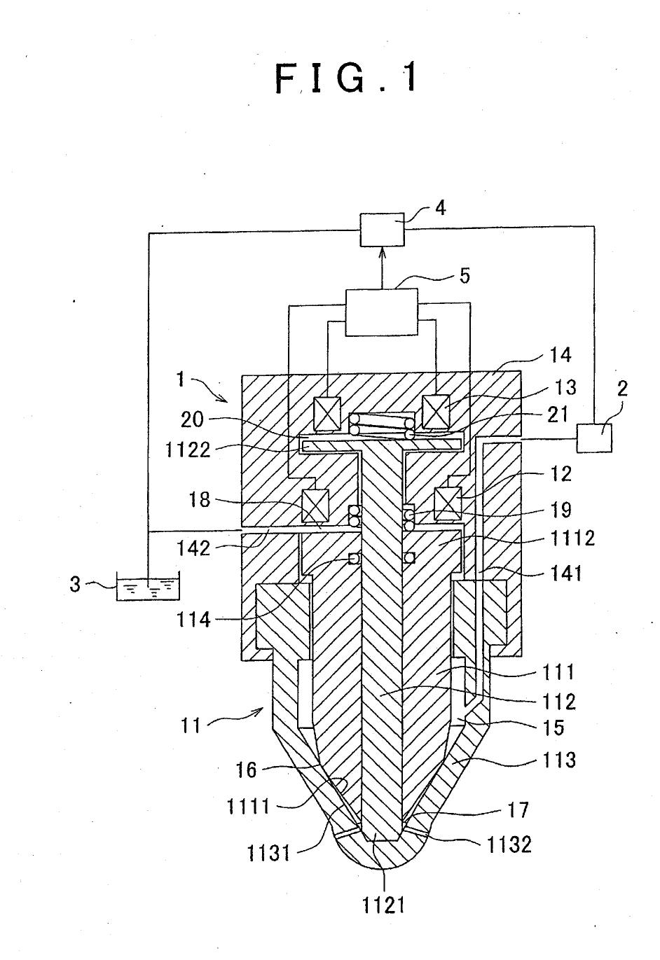

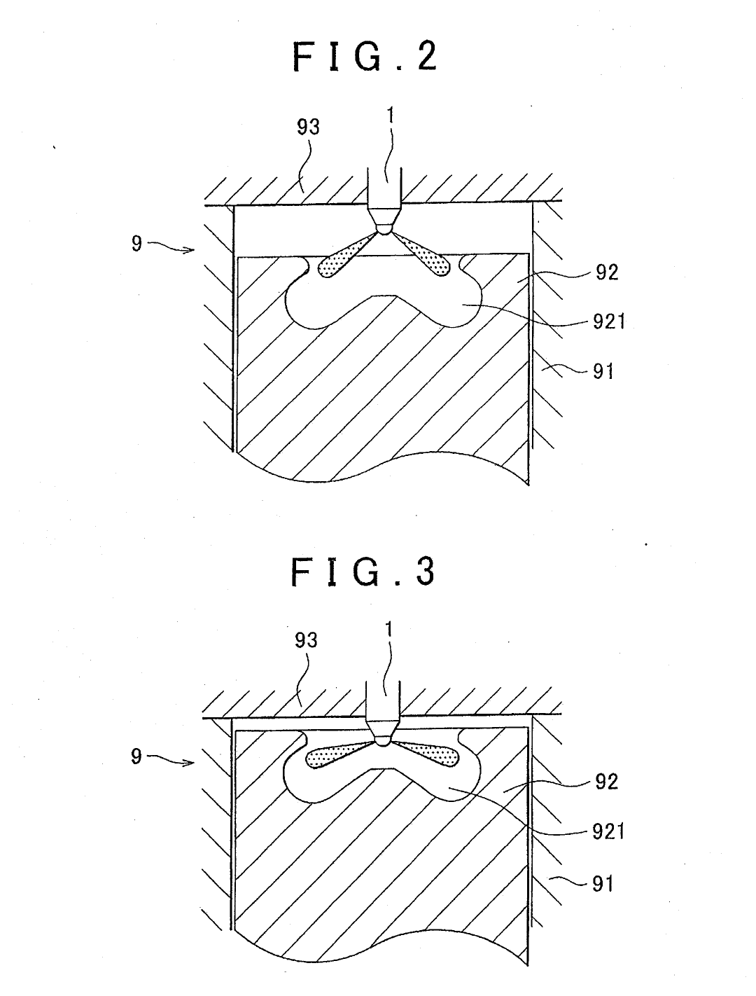

A first embodiment of the invention will be described. FIG. 1 is a schematic sectional view showing a fuel injection control system using a fuel injection nozzle according to the first embodiment. FIGS. 2 and 3 are schematic sectional views showing directions in which fuel is injected from the fuel injection valve of FIG. 1. FIG. 2 shows an operational state in which a piston is at a position away from the top dead center. FIG. 3 shows an operational state in which the piston is at a position near the top dead center.

As shown in FIGS. 2 and 3, a compression ignition internal combustion engine 9 has the piston 92 inserted in a cylinder 91 so as to be able to reciprocate, and the fuel injection valve 1 is fitted in a cylinder head 93. A combustion chamber 921 is formed in a top portion of the piston 92.

As shown in FIG. 1, the fuel injection control system includes: the fuel injection valve 1 that injects fuel into the internal combustion engine 9; an accumulator 2 in which high-pressure fuel is stored; a fuel tank 3 in which fuel is stored in a low-pressure state; a supply pump 4 that pressurizes the fuel sucked up from the fuel tank 3 and supplies the pressurized fuel to the accumulator 2; and a control circuit 5, which functions as a control means for controlling the operation of the fuel injection valve 1 and the supply pump 4. More specifically, the control circuit 5 receives various signals, including a crank angle signal, and controls fuel injection timing, fuel injection duration, the fuel injection direction (described later in detail), and the amount of discharge of fuel from the supply pump 4.

The fuel injection valve 1 includes: the fuel injection nozzle 11 that injects fuel when the fuel injection valve 1 is opened; a first drive portion 12 that drives an outer needle 111 of the fuel injection nozzle 11; a second drive portion 13 that drives an inner needle 112 of the fuel injection nozzle 11; and a holder body 14, made of magnetic metal, that holds the first and second drive portions 12 and 13. In this embodiment, solenoids that drive the outer needle 111 and the inner needle 112 by means of magnetic attractive force are used as the first and second drive portions 12 and 13.

The fuel injection nozzle 11 has the cylindrical outer needle 111, made of magnetic metal, that is slidably inserted, in a cylindrical nozzle body 113, made of metal and one end of which is closed, and the fuel injection nozzle 11 further has the cylindrical inner needle 112, made of magnetic metal, that is slidably inserted in the outer needle 111.

An O-ring 114 is disposed in a groove formed on the inner circumferential surface of the outer needle 111, and the O-ring 114 seals the interface between the outer needle 111 and the inner needle 112.

A tapered valve seat 1131 is formed in the nozzle body 113, and injection holes 1132 to inject high-pressure fuel into the internal combustion engine 9 (see FIG. 2) are made in the valve seat 1131. A tapered seat surface 1111 is formed in the outer needle 111. The seat surface 1111 is brought into contact with and moved away from the valve seat 1131 as the outer needle 111 is moved back and forth, whereby the injection holes 1132 are opened and closed.

A fuel room 15 to which the high-pressure fuel is supplied from the accumulator 2 through a high-pressure fuel passage 141 in the holder body 14 is formed between the inner circumferential surface of the nozzle body 113 and the outer circumferential surface of the outer needle 111. A sack 17 is defined by the valve seat 1131 and the seat surface 1111 downstream of the fuel room 15, more specifically, downstream of a seat portion 16 at which the valve seat 1131 and the seat surface 1111 are brought into contact with each other.

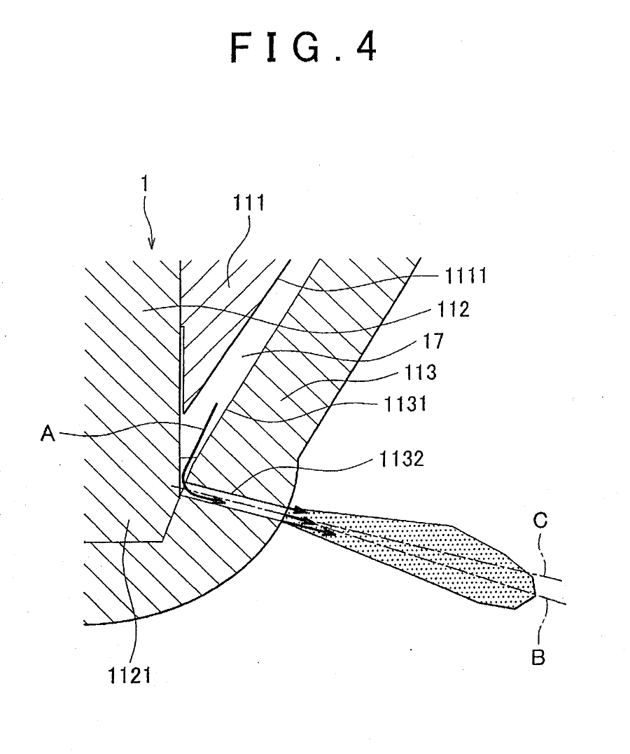

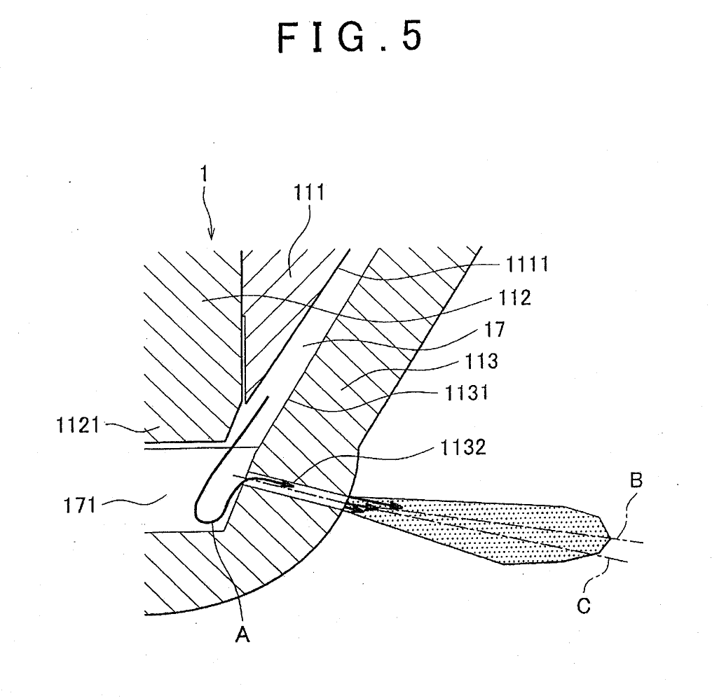

FIGS. 4 and 5 are sectional views showing the vicinity of the injection hole 1132 of the fuel injection nozzle 11 in an enlarged manner. FIG. 4 shows an operational state in which the amount of lift of the inner needle 112 is zero. FIG. 5 shows an operational state in which the amount of lift of the inner needle 112 is maximum. A tip portion 1121 of the inner needle 112 moves into and out of a space 171 (hereinafter referred to as the sack-tip-portion space) that is part of the sack 17 downstream of the injection holes 1132.

Referring back to FIG. 1, a first brim portion 1112 is formed at an end portion of the outer needle 111 on the side opposite to the seat surface 1111 side. In addition, a first pressure chamber 18 is provided between the holder body 14 and an end surface of the first brim portion 1112 on the side opposite to the seat surface 1111 side. The first pressure chamber 18 is connected to the fuel tank 3 through a low-pressure fuel passage 142 in the holder body 14 and kept at a low pressure all the time. A first spring 19 that urges the outer needle 111 in the valve closing direction is disposed in the first pressure chamber 18. A first drive portion 12 is provided in the holder body 14, the first drive portion 12 facing the end surface of the first brim portion 1112 on the side opposite to the seat surface 1111 side. The outer needle 111 is urged in the valve opening direction by the magnetic attractive force of the first drive portion 12. The control circuit 5 controls the timing and duration of energization of the first drive portion 12.

A second brim portion 1122 is formed at an end portion of the inner needle 112 on the side opposite to the tip portion 1121 side. The second brim portion 1122 is disposed in a second pressure chamber 20 provided in the holder body 14. The second pressure chamber 20 communicates with the first pressure chamber 18 through the gap between the inner needle 112 and the holder body 14. Thus, the second pressure chamber 20 is kept at a low pressure all the time. A second spring 21 is disposed in the second pressure chamber 20, the second spring 21 facing an end surface of the second brim portion 1122 on the side opposite to the tip portion 1121 side. The second spring 21 urges the inner needle 112 in the direction in which the tip portion 1121 enters the sack-tip-portion space 171 (see FIG. 5).

In the holder body 14, the second drive portion 13 is disposed facing the end surface of the second brim portion 1122 on the side opposite to the tip portion 1121 side. The inner needle 112 is urged by the magnetic attractive force of the second drive portion 13 in the direction in which the tip portion 1121 moves out of the sack-tip-portion space 171. The control circuit 5 controls the timing and duration of energization of the second drive portion 13 and controls the applied voltage to perform control so that the magnetic attractive force is continuously varied.

Operation of the fuel injection control system configured as described above will be described below. The supply pump 4 is driven by the internal combustion engine 9 to pressurize the fuel sucked up from the fuel tank 3 and supply the pressurized fuel to the accumulator 2. The amount of discharge of fuel from the supply pump 4 is controlled by the control circuit 5 so that the fuel pressure in the accumulator 2 becomes the target pressure. The fuel in the accumulator 2 is supplied to the fuel room 15 through the high-pressure fuel passage 141.

When the first drive portion 12 is not energized, the outer needle 111 is urged in the valve closing direction by the first spring 19 and the seat surface 1111 is in contact with the valve seat 1131, whereby the injection holes 1132 are closed. On the other hand, when the first drive portion 12 is energized, the outer needle 111 is attracted and lifted against the urging force of the first spring 19, so that the seat surface 1111 moves away from the valve seat 1131 and the injection holes 1132 are opened, whereby fuel is injected through the injection holes 1132. Thus, the fuel injection timing and the fuel injection duration are controlled by controlling the energization of the first drive portion 12.

When the second drive portion 13 is not energized, the inner needle 112 is urged by the second spring 21. In this case, as shown in FIG. 4, the amount of lift of the inner needle 112 is zero (that is, the tip end surface of the inner needle 112 is in contact with the bottom of the sack 17), and therefore, the tip end portion 1112 of the inner needle 112 is in the sack-tip-portion space 171. In this state, as shown by the arrow A, the fuel flowing through the sack 17 flows from the seat portion 16 side directly toward the injection holes 1132. Thus, as shown by the three arrows at the outlet of the injection hole 1132, within the injection hole 1132, the flow speed distribution is such that the flow speed in the upper area (in the side closer to the seat portion 16) of the injection hole 1132 is low (that is, the flow rate is low) and the flow speed in the lower area (in the side closer to the bottom of the sack 17) of the injection hole 1132 is high (that is, the flow rate is high). Accordingly, the fuel injection direction B is downward relative to the injection-hole central axis C.

On the other hand, when a voltage equal to or higher than a predetermined value is applied to the second drive portion 13, the inner needle 112 is attracted against the urging force of the second spring 21. In this case, as shown in FIG. 5, the amount of lift of the inner needle 112 becomes maximum, and the tip portion 1121 of the inner needle 112 completely comes out of the sack-tip-portion space 171. In this state, as shown by the arrow A, the fuel flowing through the sack 17 flows toward the sack-tip-portion space 171. The direction of the flow of the fuel is then turned around at the bottom of the sack 17 and thus, the fuel is made to flow from the bottom side of the sack 17 toward the injection hole 1132. Thus, as shown by the three arrows at the outlet of the injection hole 1132, within the injection hole 1132, the flow speed distribution is such that the flow speed in the upper area of the injection hole 1132 is high and the flow speed in the lower area of the injection hole 1132 is low. Accordingly, the fuel injection direction B is upward relative to the injection-hole central axis C.

When the voltage applied to the second drive portion 13 is controlled to be less than a predetermined value, the amount of lift of the inner needle 112 is less than the maximum amount, and control is performed so that the amount of lift of the inner needle 112 is continuously varied according to the value of the applied voltage. When the amount of lift of the inner needle 112 is controlled to be in a middle range and the inner needle 112 occupies part of the sack-tip-portion space 171, the direction of the flow of part of the fuel flowing through the sack 17 is turned around at the bottom of the sack 17 and the part of the fuel flows from the bottom side of the sack 17 toward the injection hole 1132, and the remaining fuel is made to flow from the seat 16 side directly toward the injection hole 1132. Accordingly, the fuel injection direction becomes close to the central axis of the injection hole.

Thus, by controlling the amount of lift of the inner needle 112 within the range from zero to the maximum amount, it is possible to control the fuel injection direction within the range between the most downward direction shown in FIG. 4 and the most upward direction shown in FIG. 5.

In order to prevent fuel from sticking to the wall surface of the cylinder 91, more specifically, in order to inject fuel to an optimum area in the combustion chamber 921 in the piston 92, the control circuit 5 controls the amount of lift of the inner needle 112, that is, controls the fuel injection direction, according to the position of the piston 92 based on the positional information of the piston 92 obtained based on the crank angle signal.

Specifically, in the compression stroke, as the piston 92 approaches the top dead center, the amount of lift of the inner needle 112 is continuously varied from zero (the fuel injection direction is the most downward as shown in FIG. 4) to the maximum amount (the fuel injection direction is the most upward as shown in FIG. 5). In the expansion stroke, as the piston 92 moves away from the top dead center, the amount of lift of the inner needle 112 is continuously varied from the maximum amount to zero.

When the amount of lift of the inner needle 112 is controlled according to the position of the piston 92 in this way, the fuel injection direction is made downward as shown in FIG. 2 when the piston 92 is at a position away from the top dead center, and the fuel injection direction is made upward as shown in FIG. 3 when the piston 92 is at a position near the top dead center. Thus, it is possible to ensure that fuel is injected to an optimum area in the combustion chamber 921 in the piston 92. In addition, in either of the case where fuel is injected while the piston 92 is ascending and the case where fuel is injected while the piston 92 is descending, it is possible to ensure that fuel is injected to an optimum area in the combustion chamber 921 in the piston 92.

While in this embodiment, control is performed so that the voltage applied to the second drive portion 13 is continuously varied, control may be performed so that an electric current supplied to the second drive portion 13 is continuously varied, whereby the magnetic attractive force of the second drive portion 13 is continuously varied and therefore, the amount of lift of the inner needle 112 is continuously varied.

### Second Embodiment

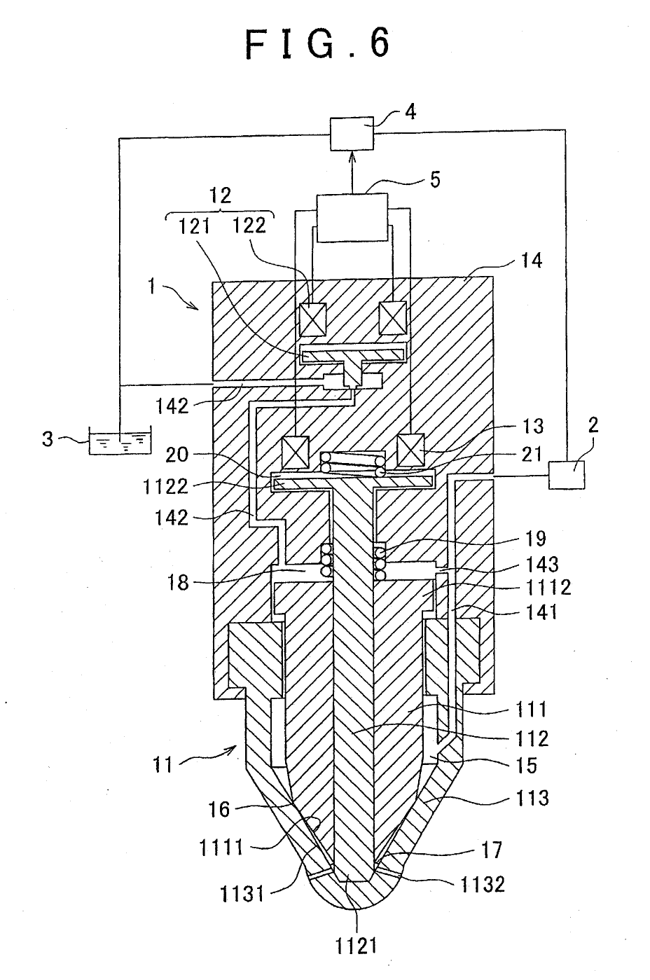

A second embodiment of the invention will be described. FIG. 6 is a schematic sectional view showing a fuel injection control system using a fuel injection nozzle according to the second embodiment.

This embodiment differs from the first embodiment in the configuration of the first drive portion 12 that drives the outer needle 111. Because the second embodiment is similar to the first embodiment in other features, only the differences between the first and second embodiments will be described.

In FIG. 6, the first pressure chamber 18 is connected to the high-pressure fuel passage 141 through a communication hole 143 in the holder body 14. The outer needle 111 is urged in the valve closing direction by the pressure in the first pressure chamber 18, and urged in the valve opening direction by the pressure in the fuel room 15. The first drive portion 12 includes a valve element 121, made of magnetic metal, that opens and closes the low-pressure fuel passage 142 and a solenoid 122 that attracts the valve element 121 in the valve opening direction when energized. The control circuit 5 controls the timing and duration of energization of the solenoid 122.

When the solenoid 122 is not energized, the low-pressure fuel passage 142 is closed by the valve element 121, so that the outer needle 111 is urged in the valve closing direction by the pressure of the high-pressure fuel in the first pressure chamber 18 and the seat surface 1111 is in contact with the valve seat 1131, whereby the injection holes 1132 are closed.

On the other hand, when the solenoid 122 is energized, the valve element 121 is attracted by the solenoid 122 and the low-pressure fuel passage 142 is opened, so that the first pressure chamber 18 is made to communicate with the fuel tank 3 through the low-pressure fuel passage 142 and the pressure in the first pressure chamber 18 is reduced. Then, the outer needle 111 is driven by the pressure in the fuel room 15 in the valve opening direction against the urging force of the first spring 19 and the seat surface 1111 moves away from the valve seat 1131 to open the injection holes 1132, whereby fuel is injected through the injection holes 1132.

In this embodiment, because the outer needle 111 is urged in the valve closing direction by the pressure of the high-pressure fuel in the first pressure chamber 18 and the outer needle 111 is driven by the pressure in the fuel room 15 in the valve opening direction against the urging force of the first spring 19, the spring force of the first spring 19 is set lower than that in the case of the first embodiment.

Meanwhile, also in this embodiment, the amount of lift of the inner needle 112 is controlled according to the position of the piston 92 (see FIGS. 2 and 3) as in the case of the first embodiment, it is possible to ensure that fuel is injected to an optimum area in the combustion chamber 921 in the piston 92 (see FIGS. 2 and 3) in either of the case where fuel is injected while the piston 92 is ascending and the case where fuel is injected while the piston 92 is descending.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1.-11. (canceled)

12. A fuel injection nozzle comprising:
a nozzle body in which an injection hole is formed;
a cylindrical outer needle, slidably inserted in the nozzle body, that is brought into contact with and moved away from the nozzle body at a seat portion to open and close a fuel supply passage leading to the injection hole; and
an inner needle, slidably inserted in the outer needle, that is projected out of and retracted into the outer needle on the injection hole side relative to the seat portion, thereby changing a state of flow of fuel around a portion, at which the injection hole is opened, to change a direction in which the fuel is injected through the injection hole.

13. The fuel injection nozzle according to claim 12, wherein
a sack is defined, downstream of the seat portion, by the outer needle, the inner needle, and the nozzle body, and
the inner needle is switched between a first state in which the inner needle occupies an area of the sack downstream of the portion, at which the injection hole is opened, and a second state in which the inner needle does not occupy the area of the sack.

14. The fuel injection nozzle according to claim 13, wherein
when the inner needle is in the first state, the state of flow of the fuel is such that the fuel flows from the seat portion side directly toward the injection hole, so that a flow speed of the fuel in the injection hole is higher in one side of the injection hole than in the other side of the injection hole that is closer to the seat portion than the one side and, when the inner needle is in the second state, the state of flow of the fuel is such that the fuel flows to the injection hole via the area of the sack downstream of the portion, at which the injection hole is opened, so that the flow speed of the fuel in the injection hole is lower in the one side of the injection hole than in said the other side of the injection hole that is closer to the seat portion than the one side.

15. A fuel injection valve comprising:
a fuel injection nozzle according to claim 12,
a first drive portion that drives the outer needle; and
a second drive portion that drives the inner needle.

16. The fuel injection valve according to claim 15, wherein:
the outer needle is made of magnetic metal, has at one end a seat surface that is brought into contact with the nozzle body at the seat portion, and has at the other end a first brim portion;
the first drive portion includes a solenoid that drives the outer needle by magnetic attractive force; and
the first drive portion is located facing an end surface of the first brim portion on the side opposite to the seat surface side.

17. The fuel injection valve according to claim 15, wherein
a closing-direction pressure chamber that applies, to the outer needle, a pressure that urges the outer needle in a closing direction and an opening-direction pressure chamber that applies, to the outer needle, a pressure that urges the outer needle in an opening direction are provided; and
the first drive portion includes a valve element, made of magnetic metal, for reducing the pressure of the closing-direction pressure chamber and a solenoid that attracts the valve element in a valve opening direction when the solenoid is energized.

18. A fuel injection control system comprising:
the fuel injection valve according to claim 15; and
a controller that controls operation of the first and second drive portions.

19. The fuel injection control system according to claim 18, wherein the second drive portion is designed to perform control so that an amount of lift of the inner needle is continuously varied.

20. The fuel injection control system according to claim 19, wherein the second drive portion includes a solenoid that drives the inner needle by magnetic attractive force.

21. The fuel injection control system according to claim 19, wherein the fuel injection control system is installed in an internal combustion engine in which a piston reciprocates, and
the controller controls the second drive portion so that the closer to a top dead center the piston is, the larger the amount of lift of the inner needle is.

22. A fuel injection nozzle comprising:
a nozzle body in which an injection hole is formed;
a cylindrical outer needle that is brought into contact with and moved away from the nozzle body to open and close the injection hole; and
an inner needle slidably inserted in the outer needle,
wherein: a space that is defined, downstream of a seat portion at which the outer needle and the nozzle body are brought into contact with each other, by the inner needle, the outer needle, and the nozzle body is a sack;
an area of the sack into and out of which a tip portion of the inner needle is moved and that is downstream of a portion, at which the injection hole is opened, is a sack-tip-portion space;
when the outer needle is lifted and the inner needle is not lifted, fuel flows from the seat portion side directly toward the injection hole, so that a flow speed of the fuel in the injection hole is higher in one side of the injection hole than in the other side of the injection hole that is closer to the seat portion than the one side; and,
when the outer needle is lifted and the inner needle is lifted, the fuel flows to the injection hole via the sack-tip-portion space, so that the flow speed of the fuel in the injection hole is lower in the one side of the injection hole than in said the other side of the injection hole that is closer to the seat portion than the one side.

23. A fuel injection valve comprising:
a fuel injection nozzle according to claim 22;
a first drive portion that drives the outer needle; and
a second drive portion that drives the inner needle.

24. The fuel injection valve according to claim 23, wherein:
the outer needle is made of magnetic metal, has at one end a seat surface that is brought into contact with the nozzle body at the seat portion, and has at the other end a first brim portion;
the first drive portion includes a solenoid that drives the outer needle by magnetic attractive force; and
the first drive portion is located facing an end surface of the first brim portion on the side opposite to the seat surface side.

25. The fuel injection valve according to claim 23, wherein
a closing-direction pressure chamber that applies, to the outer needle, a pressure that urges the outer needle in a closing direction and an opening-direction pressure chamber that applies, to the outer needle, a pressure that urges the outer needle in an opening direction are provided; and
the first drive portion includes a valve element, made of magnetic metal, for reducing the pressure of the closing-direction pressure chamber and a solenoid that attracts the valve element in a valve opening direction when the solenoid is energized.

26. A fuel injection control system comprising:
the fuel injection valve according to claim 23; and
a controller that controls operation of the first and second drive portions.

27. The fuel injection control system according to claim 26, wherein the second drive portion is designed to perform control so that an amount of lift of the inner needle is continuously varied.

28. The fuel injection control system according to claim 27, wherein the second drive portion includes a solenoid that drives the inner needle by magnetic attractive force.

29. The fuel injection control system according to claim 27, wherein the fuel injection control system is installed in an internal combustion engine in which a piston reciprocates, and
the controller controls the second drive portion so that the closer to a top dead center the piston is, the larger the amount of lift of the inner needle is.
